(19) United States
(12) Patent Application Publication
(10) Pub. No.: US 2024/0198354 A1
(43) Pub. Date: Jun. 20, 2024

(54) SEPARATION OF MATERIAL TO BE SEPARATED IN A CENTRIFUGAL FORCE SEPARATOR

(71) Applicant: MONTANUNIVERSITÄT LEOBEN, Leoben (AT)

(72) Inventors: Markus BAUER, Feldbach (AT); Daniel SCHWABL, Leoben (AT)

(21) Appl. No.: 18/555,488

(22) PCT Filed: Apr. 14, 2022
(86) PCT No.: PCT/EP2022/060085

§ 371 Date: Oct. 13, 2023

(30) Foreign Application Priority Data
Apr. 15, 2021 (EP) 21168568.0

(51) Int. Cl. B03B 5/34; B03B 11/00

(52) U.S. Cl. CPC B03B 5/34; B03B 11/00

(57) ABSTRACT

The disclosure relates to a method for separating material to be separated in a centrifugal force separator (CFS), wherein a separating medium is introduced into the CFS in such a way that a vortex with an air core is generated inside the CFS, wherein the material to be separated is introduced into the CFS via at least one forced conveying device. Furthermore, the disclosure relates to an apparatus for carrying out said method, comprising a CFS having an inlet for the material to be separated for introducing material to be separated and a separating medium inlet for introducing a separating medium, wherein the apparatus comprises at least one forced conveying device connected to the inlet for the material to be separated.

This application is the U.S. national phase of International Application No. PCT/EP2022/060085 filed 14 Apr. 2022 which designated the U.S. and claims priority to European Patent Application No. 21 168 568.0 filed 15 Apr. 2021, the entire contents of each of which are hereby incorporated herein by reference.

### FIELD OF THE DISCLOSURE

Embodiments of the disclosure relate to a method for separating material to be separated in a centrifugal force separator (CFS) and to an apparatus for carrying out this method.

### BACKGROUND

CFS enable the separation of particles according to their density in relation to the density of a separating medium. Originally developed for coal preparation, CFS are now used for a wide variety of sorting tasks.

CFS typically comprise cylindrical housings whose longitudinal axis is usually oriented at an angle, for example between 20° and 40°, to the horizontal during operation. A separating medium is usually introduced through an involute-shaped inlet in the housing sheath (jacket, shell) in a lower region of the CFS, so that a vortex or turbulent flow with an air core is generated along the longitudinal axis of the CFS and the separating medium exits again through an involute-shaped outlet in the upper region of the housing sheath. The material to be separated is introduced through an inlet usually centrally located at an upper front side of the cylindrical housing. Low density particles float up at the interface between the separating medium and the air core and are conveyed by gravity along the longitudinal axis of the CFS to an outlet centrally located at the lower rear side of the cylindrical housing. High-density particles sink into the separating medium, are forced radially outward by centrifugal force, and exit the CFS through a separating medium outlet at the top of the housing. The particles contained in the material to be separated can thus be sorted according to their density in relation to the density of the separating medium.

A variety of different CFS are known from the state of the art. Among other things, CFS are also known as dense media separators (DMS), cylindrical cyclone separators, dynamic separators, or under the product names Dyna Whirlpool separators, TriFlo separators and LARCODEMS (large coal dense media separators). Suitable CFS are disclosed, for example, in DE 198 47 229 A1 and WO 02/00352 A1.

CN 106 861 896 A discloses a centrifugal force separator, wherein a conveyor belt conveys the material to be separated, which falls into the centrifugal force separator at the end of the conveyor belt due to gravity.

CN 109 701 732 A discloses a centrifuge on which a feed unit is arranged, the feed unit comprising a screw conveyor which terminates before the centrifuge.

JP 2014 230498 A discloses a tissue separator comprising a centrifugal force separator. Therein, on the one hand, a first solution with tissue characters is introduced from above via a first inlet opening and a second liquid is introduced via a lateral second opening to generate a vortex in the conically tapered container.

CN 208 928 368 U discloses a conveying device for conveying material to be separated to a centrifugal force separator. Particles fall from a discharge plate into the centrifugal force separator.

EP 0 876 847 A2 discloses a method for separating mixed plastics. A separating liquid is supplied via a stirred tank.

Although many prior art CFS are basically well suited for separating different materials, they have disadvantages that affect the efficiency and stability of the separation process. In particular, the throughput of the separation process is often unsatisfactory and interruptions may occur. In many cases, an extensive pre-sorting of the material to be separated is also necessary, which may further impair the efficiency of the method.

Thus, there may be a need to alleviate or eliminate at least some disadvantages of the prior art. There may be also a need to provide an efficient separation process with high stability and high throughput for different types of material to be separated.

### SUMMARY OF THE DISCLOSURE

An embodiment of the disclosure provides a method for separating material to be separated in a centrifugal force separator (CFS), wherein a separating medium is introduced into the CFS such that a vortex with an air core is generated inside the CFS, wherein the material to be separated is introduced into the CFS via at least one forced conveying device.

Another embodiment of the disclosure provides an apparatus for carrying out the method described above, the apparatus comprising a CFS having an inlet for the material to be separated (separating material inlet) for introducing material to be separated and a separating medium inlet for introducing a separating medium, the apparatus comprising at least one forced conveying device connected to the inlet for the material to be separated.

In the CFS known from the prior art, the material to be separated is typically introduced by gravity alone. The particles slide, for example, from a hopper into a hose or pipe which opens into the CFS. Alternatively, the material to be separated is flushed in as a suspension.

In connection with embodiments of the present disclosure, it has been shown that major disadvantages of the known separation processes may be overcome if the material to be separated is force-conveyed into the CFS. This type of material feed enables a continuous and controllable feed into the CFS. Material bridges and caking may be avoided or reduced. Clogging occurs less frequently, which reduces maintenance and increases plant availability. Continuous material feed enables a more stable separation process, resulting in high separation efficiency and allowing high throughputs to be maintained. Forced conveying also enables better flexibility of the separation process with respect to heterogeneous particle collectives, reducing the need for pre-sorting of the material to be separated.

In order to force the material to be separated into the CFS, at least one forced conveying device is connected to the inlet for the material to be separated of the CFS in such a way that a forced conveying of the material to be separated into the CFS is enabled. Advantageously, the forced conveying device is flanged directly to the inlet for the material to be separated of the CFS. For example, a flange may be provided with a flat gasket, a flexible sealing compound or an O-ring and tightened, whereby a tight connection may be achieved. Alternatively, the forced conveying device may be connected to the CFS, for example, via a sleeve with sealing lips or, if the inlet for the material to be separated is designed as a pipe section (lining pipe), via an annular space seal or press ring seal. In a preferred embodiment, the forced conveying device is connected to the inlet for the material to be separated via a compensator. This has the advantage that, for example, shrinkage may be absorbed and compensated.

### DESCRIPTION OF EXEMPLARY EMBODIMENTS

Additional advantageous embodiments of the method and the apparatus according to exemplary embodiments of the disclosure are described in the following.

Any conveying equipment that provides forced conveying is suitable in connection with the method and the apparatus according to the disclosure. The forced conveying device may, for example, be a pipe in which there is a rotating screw or spiral which provides for the forced conveying of the material to be separated. Preferably, the material to be separated is introduced via a screw conveyor or a spiral conveyor provided as a forced conveying device. According to a preferred embodiment, the forced conveying device is therefore a screw conveyor or a spiral conveyor.

In connection with embodiments of the present disclosure, it is favorable if the feed via the forced conveying device is preferably infinitely (seamlessly) controllable via a drive unit. In a preferred embodiment of the apparatus according to the present disclosure, the forced conveying device therefore has a preferably infinitely controllable drive unit. This enables precise control of the material feed, ensuring a high throughput without overloading the CFS. In addition, the separation process may be flexibly adapted to the type of the material to be separated by controlling the conveying speed. Preferably, therefore, the forced conveying device is driven by a motor whose speed can be infinitely controlled.

In a preferred embodiment, the material to be separated is introduced into the forced conveying device from a receiver tank with a stirring unit. The forced conveying device is therefore preferably connected to a receiver tank having a stirring unit. The stirring unit allows material bridges to be reduced when feeding the forced conveying device, which further increases the efficiency and stability of the separation material feed.

In a particularly preferred embodiment, the material to be separated is introduced into the forced conveying device from a receiver tank with a discharge bottom. The forced conveying device is therefore preferably connected to a receiver tank having a discharge bottom. The discharge bottom is preferably a moving bottom, for example a screw discharge bottom. In this embodiment, the bottom of the receiver tank is formed at least partially, preferably completely, by screws, which enables a particularly uniform feeding of the forced conveying device. The formation of material bridges may be particularly effectively reduced. The flow of the material to be separated may also be varied over a wide range by changing the rotational speed of the screws.

In the context of embodiments of the disclosure, it is preferred if the CFS has a substantially cylindrical housing for receiving the separating medium and the material to be separated. Preferably, therefore, the CFS has a housing with a front side and a rear side which are connected via a substantially cylindrical housing sheath (jacket, shell). The front side and the rear side may also be referred to as the lid and the bottom of the CFS. CFSs such as those disclosed in DE 198 47 229 A1 and WO 02/00352 A1 are particularly preferred.

Preferably, the CFS has at least one inlet for the material to be separated and at least one separating medium inlet. The inlet for the material to be separated and the separating medium inlet are preferably separate inlets and it is preferred that the material to be separated and the separating medium are introduced into the CFS separately. Separation systems in which the material to be separated and the separating medium are introduced together are also known in the state of the art. However, one of the advantages of separate introduction is that the flow of the separating medium is easier to control.

The material to be separated is preferably introduced at the front side of the CFS. In particular, it is preferred that the material to be separated is introduced substantially into the center of the front side of the CFS. The inlet for the material to be separated is therefore preferably arranged at the front side of the CFS, in particular substantially centrally at the front side of the CFS.

Preferably, the material to be separated is introduced substantially in the direction of the longitudinal axis of the CFS. The longitudinal axis of the forced conveying device is therefore preferably aligned substantially flush with the longitudinal axis of the CFS. However, it is also possible for the longitudinal axis of the forced conveying device to be aligned at an angle to the longitudinal axis of the CFS, in particular if more than one forced conveying device is connected to the CFS.

Preferably, the CFS has a light material outlet, which is preferably arranged at the rear side of the CFS opposite the front side, in particular substantially centrally at the rear side. During operation, low-density material may thus migrate from an inlet for the material to be separated at the front side through an air column forming along the longitudinal axis of the CFS to the light material outlet at the rear side of the CFS, where it may be recovered as a light material fraction.

Preferably, the separating medium inlet of the apparatus according to the disclosure is an involute-shaped inlet at the preferably substantially cylindrical housing sheath of the CFS. It is advantageous if the separating medium inlet is arranged at the housing sheath adjacent to the rear side of the CFS, in particular if the separating medium inlet is adjacent to the rear side of the CFS. Preferably, the separating medium inlet is arranged substantially in a tangential direction to a substantially cylindrical housing sheath of the CFS. In the method according to the disclosure, the separating medium is preferably introduced through such a separating medium inlet. Preferably, therefore, the separating medium is introduced adjacent to the rear side of the CFS. Preferably, the separating medium is introduced substantially tangentially to the envelope of the separating medium flow.

In a preferred embodiment of the method according to the disclosure, the material to be separated is introduced into the CFS via at least one further forced conveying device. Preferably, therefore, the apparatus according to the disclosure has at least one further forced conveying device connected to the inlet for the material to be separated. In this context, it is not absolutely necessary that the multiple forced conveying devices open into a single opening in the housing of the CFS. The inlet for the material to be separated may also comprise several adjacent openings, to each of which a forced conveying device is connected. It is particularly preferred if the material to be separated is introduced into the CFS via at least two, in particular at least three forced conveying devices; or if the apparatus according to the disclosure comprises at least two, in particular at least three forced conveying devices connected to the inlet for the material to be separated. The provision of several forced conveying devices allows even greater flexibility in the introduction of the material to be separated. Advantageously, different materials to be separated, for example with respect to composition or size distribution, may be introduced via separate forced conveying devices. Furthermore, the forced conveying devices may be operated at conveying speeds that differ from one another. Thus, the conveying speed may be adapted to the respective material to be separated and a high throughput may be ensured without overloading the CFS. In addition, the ratio in which the different materials to be separated are fed into the CFS may be controlled.

The preferred embodiments described herein in connection with a single forced conveying device apply equally to each of the forced conveying devices of the methods and the apparatuses according to the disclosure, which concern the use or presence of multiple forced conveying devices. It is therefore preferred, for example in connection with the method and the apparatus according to the disclosure, that at least one, in particular preferably each, of the forced conveying devices is a screw conveyor or a spiral conveyor. It is also preferred that at least one, in particular preferably each, of the forced conveying devices is connected to a receiver tank comprising a discharge bottom or a stirring unit.

Preferably, the introduction is carried out via the forced conveying devices in different directions that deviate from the longitudinal axis of the CFS. With respect to the apparatus according to the disclosure, it is therefore preferred if the forced conveying devices are arranged at an angle to each other. Preferably, therefore, the forced conveying devices each have a longitudinal axis, the longitudinal axes being arranged at an angle to one another. In a preferred embodiment, the longitudinal axis of one forced conveying device is aligned substantially flush with the longitudinal axis of the CFS, while the longitudinal axis of at least one further forced conveying device is aligned at an angle to the longitudinal axis of the CFS, preferably between 5° and 80°, even more preferably between 10° and 60°, in particular between 15° and 45º. In a preferred embodiment, the introduction is carried out via forced conveying devices whose longitudinal axes are arranged at an angle of between 10° and 120°, preferably between 20° and 100°, even more preferably between 30° and 80°, most preferably between 40° and 60° to each other. Preferably, the introduction is carried out via at least three forced conveying devices, the angle between the longitudinal axes of each pair of forced conveying devices being between 10° and 120°, preferably between 20° and 100°, even more preferably between 30° and 80°, most preferably between 40° and 60°. In the context of the apparatus according to the disclosure, it is also preferred if the angle between the longitudinal axes of the forced conveying devices is between 10º and 120°, preferably between 20° and 100°, even more preferably between 30° and 80°, most preferably between 40° and 60°. Preferably, the apparatus has at least three forced conveying devices, the angle between the longitudinal axes of each pair of forced conveying devices being between 10° and 120°, preferably between 20° and 100°, even more preferably between 30° and 80°, most preferably between 40° and 60°. The arrangements described allow several forced conveying devices to be operated simultaneously in an efficient manner and the material to be separated from each forced conveying device to be fed into the air column forming in the CFS.

The method and the apparatus according to the disclosure are suitable for separating a wide range of different types of material to be separated, for example minerals, coal and waste of any kind, in particular post-consumer waste or post-industrial waste. The use of the method according to the disclosure is particularly advantageous for plastic waste, or used plastic. Due to their shape, volume and low weight, waste, in particular used plastic, very easily leads to blockages in CFS as used in the prior art. In particular, flat particle collectives, e.g. plastic films, may easily become entangled and agglomerate. In a preferred embodiment, the material to be separated therefore comprises plastics. The method and the apparatus according to the disclosure are excellently suited for the separation of such materials, since the forced conveying prevents blockages, or reduces them considerably.

Preferably, the proportion of plastics in the material to be separated is at least 5% by weight, preferably at least 10% by weight, even more preferably at least 25% by weight, even more preferably at least 50% by weight, in particular at least 75% by weight. The proportion of plastics in the material to be separated may preferably be up to 90% by weight, preferably up to 100% by weight. The plastics are preferably selected from polyethylene (PE), polypropylene (PP), polyvinyl chloride (PVC), polyethylene terephthalate (PET) and polystyrene (PS), or mixtures thereof. Preferably, the plastics are polyolefins, in particular PE and/or PP. Polyolefins are particularly suitable for plastics recycling in thermal-chemical conversion plants. It is therefore preferred if the proportion of polyolefins, in particular the proportion of PE and/or PP, in the material to be separated is at least 1% by weight, preferably at least 5% by weight, more preferably at least 10% by weight, in particular at least 20% by weight.

In a preferred embodiment of the method according to the disclosure, the material to be separated is moistened before being introduced into the CFS. It has been shown that the use of wet or moist material to be separated may lead to a particularly efficient separating process, since the transfer of material from the air column into the separating medium may be facilitated. For example, the transfer of hydrophobic plastics contained in the material to be separated from the air core into water as the separating medium may be facilitated in this way. The material to be separated is preferably moistened with the same liquid that is used as the separating medium. Preferably, the material to be separated introduced into the CFS contains at least 0.1% by weight of separating medium, preferably at least 0.5% by weight, even more preferably at least 1% by weight, in particular at least 5% by weight. Preferably, however, the material to be separated introduced into the CFS contains less than 80 wt. % separating medium, preferably less than 50 wt. %, even more preferably less than 25 wt. %, in particular less than 15 wt. %. Preferably, the material to be separated introduced into the CFS contains between 0.1 and 80 wt. % separating medium, preferably between 0.2 and 50 wt. %, even more preferably between 0.5 and 25 wt. %, even more preferably between 1 and 20 wt. %, in particular between 5 and 15 wt. % separating medium.

According to another exemplary embodiment, the material to be separated consists of a mixture of solid particles and liquids, in particular oil and solids, for example metal chips (metal shavings). Metal chips often have an oily, greasy coating, which is applied to metal components in metal processing operations and the metal chips resulting therefrom. In the centrifugal separator, the metal chips are separated from the oily coating and washed, so to speak. The heavier metal chips are conveyed along the inside of the housing sheath of the CFS by means of the separating medium to the separating medium outlet and the separated oil is conveyed centrally to the light material outlet. A washing effect is thus also included in the separation with water or aqueous solutions. There are also applications where not only the separation of the particles according to their density, but also purely superficial impurities are to be washed off, e.g. chips mixed with oil.

In connection with the method according to the disclosure, the separating medium preferably comprises water, in particular the separating medium consists of water, especially if the material to be separated comprises plastics, in particular polyolefins. Polyolefins with lower density than water may thus be efficiently separated from other materials with higher density.

According to another exemplary embodiment, the separating medium comprises at least oil (e.g. in an emulsion), or preferably consists of oil.

According to another exemplary embodiment, the separating medium comprises at least methanol, ethanol and/or isopropanol.

Accordingly, the separating medium may comprise aqueous solutions which are provided with salts or suspensions (water with fine particles such as lime powder or ferrosilicon). Furthermore, water/alcohol mixtures or oils may be used as separating medium for the separation of materials to be separated at a density in particular smaller than 1 g/cm³.

According to another exemplary embodiment, the separating medium comprises at least fat solvents, such as surfactants, in particular cationic, anionic and/or amphoteric surfactants. Thus, for example, oily coatings adhering to the material to be separated may be rinsed or better dissolved from the material to be separated.

According to another exemplary embodiment of the apparatus, the centrifugal force separator has a (cylindrical) housing with a front side at which an inlet for the material to be separated is provided. In particular, the housing is inclined with respect to a bottom surface (for example, at an angle between the center axis of the cylindrical housing and the bottom plane of 20 to 70, in particular 45 degrees), and the front surface at which the inlet for the material to be separated is provided is the upper front side. The forced conveying device is coupled to the front side in such a way that the material to be separated is forcibly conveyable through the inlet for the material to be separated. The material to be separated is thus guided through the inlet for the material to be separated at least until it enters the housing and is conveyed accordingly by forced conveying. Thus, no uncontrolled and unguided introduction of material to be separated takes place, as for example via a pure gravity transport. A forced conveying device is, for example, a screw conveyor whose screw extends up to the inlet for the material to be separated or, for example, projects through the inlet for the material to be separated into the interior of the housing.

According to another exemplary embodiment of the apparatus, the forced conveying device comprises an outlet area from which the material to be separated is forcibly conveyable into the housing. For example, the forced conveying device may have a cylindrical outer housing inside which a conveying device, such as a screw conveyor, is arranged.

According to another exemplary embodiment of the apparatus, the outlet area is formed at a free end of the forced conveying device, the forced conveying device being arranged such that the outlet area is at the inlet for the material to be separated or within the housing.

According to another exemplary embodiment of the apparatus, the outlet area has an outlet opening at a front side at the free end of the forced conveying device. Thus, the material to be separated may be discharged into the housing in the axial direction or in the conveying direction.

According to another exemplary embodiment of the apparatus, the outlet area has an outlet opening at a sheath surface of the forced conveying device. Thus, the material to be separated may be discharged into the housing transversely to the axial direction or to the conveying direction. A discharge transverse to the axial direction may in particular have advantages during separation in that the material to be separated is already introduced with the direction of introduction to the edge of the housing, thus enabling rapid removal of the heavy fraction by means of the edge flow of the separating medium. Thus, the material to be separated may be introduced primarily via the open front side of the screw conveyor or spiral conveyor, but introduction via the sheath surface is also possible. At the outlet opening, for example, holes or longitudinal slots, or a screen/perforated plate may be provided to disperse the particles or the material to be separated more uniformly in order to avoid point overcharging by larger agglomerates.

According to another exemplary embodiment of the apparatus, the outlet area of the forced conveying device is present inside the housing.

According to another exemplary embodiment of the apparatus, the forced conveying device is displaceably arranged relative to the housing, such that a position of the outlet area inside the housing is adjustable along the longitudinal axis of the (cylindrical) housing. In other words, the forced conveying device has a longitudinal axis passing through the inlet for the material to be separated, the forced conveying device being displaceable along the longitudinal axis (central axis) relative to the (e.g. cylindrical) housing. In this case, the forced conveying device may be displaced and the insertion depth of the forced conveying device into the housing is changed. This allows the residence time of the material to be separated, e.g. particles, in the CFS to be changed. This may be advantageous for certain separation tasks, e.g. if the residence time is increased.

According to another exemplary embodiment of the apparatus, the apparatus has a safety device which is configured to detect an impermissible internal pressure of the centrifugal force separator and/or an operating fault of the forced conveying device, wherein the safety device is coupled to the drive unit in such a way that, if an impermissible internal pressure of the centrifugal force separator and/or an operating fault of the forced conveying device are detected, an operating stop of the drive unit may be set. At the end of the conveyor section, for example inside the housing, there is the outlet area with outlet openings there, so that at a desired position the material to be separated may be discharged in the housing. Thus, an exact separation may be predetermined and defined, since, for example, at the desired position where the material to be separated leaves the forced conveying device, a predetermined path to the separation medium outlet of the heavy fraction and a light fraction outlet of the light fraction may be set.

Due to the forced conveying of the material to be separated, overpressure may occur in the cylinder in the event of an overload. The overpressure or jamming may be measured via the rotation of the forced conveying device, its electric motor, or by means of a pressure sensor, and an emergency stop may be initiated.

### BRIEF DESCRIPTION OF THE DRAWINGS

In the following, preferred, non-limiting embodiments of the disclosure are explained in more detail with reference to the drawings.

FIG. 1 schematically shows an apparatus according to an exemplary embodiment of the disclosure comprising a forced conveying device.

FIG. 2 schematically shows an apparatus according to another exemplary embodiment of the disclosure comprising several forced conveying devices.

FIG. 3 schematically shows an apparatus according to an exemplary embodiment of the disclosure, comprising a forced conveying device, the outlet area of which is located inside the housing of the centrifugal separator.

### DETAILED DESCRIPTION OF THE DRAWINGS

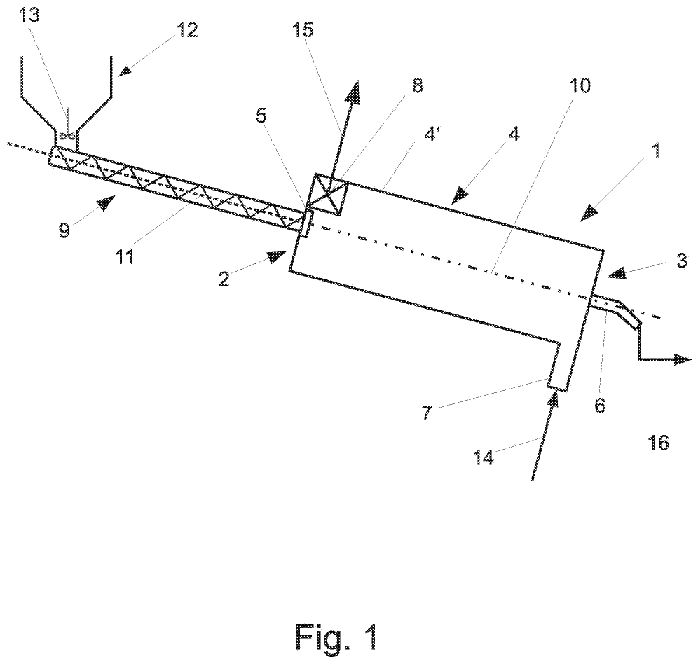

FIG. 1 shows an apparatus according to an exemplary embodiment of the disclosure. The apparatus comprises a CFS 1 with a cylindrical housing 4, in which a front side 2 and an opposite rear side 3 are connected to one another via a substantially cylindrical housing sheath 4′. The CFS 1 further comprises an inlet for the material to be separated 5 arranged substantially centrally at the front side 2 and a light material outlet 6 arranged substantially centrally at the rear side. The substantially cylindrical housing sheath 4′ comprises an involute separating medium inlet 7 adjacent the rear side 3 of the CFS and an involute separating medium outlet 8 adjacent the front side 2 of the CFS 1. The apparatus shown further comprises a forced conveying device 9 connected to the inlet for the material to be separated 5. In the embodiment shown, the longitudinal axis 10 of the CFS 1 is substantially aligned with the longitudinal axis 11 of the forced conveying device 9. The forced conveying device 9 is connected to a receiver tank 12, which has a stirring unit 13.

In connection with the embodiment shown in FIG. 1, for carrying out a method according to an exemplary embodiment of the disclosure, a separating medium 14 is introduced into the separating medium inlet 7, preferably by means of a pump with a controllable speed (not shown), so that a vortex flow with an air core is generated along the longitudinal axis 10 of the CFS 1 and the separating medium exits the CFS again through the separating medium outlet 8. Material to be separated is forcibly conveyed from the receiver tank 12 through the forced conveying device 9 into the inlet for the material to be separated 5 at the front side 2 of the CFS 1, thus being introduced substantially in the direction of the longitudinal axis 10 of the CFS 1. Low density material floats up at the interface between the separating medium and the air core and is conveyed along the longitudinal axis 10 of the CFS 1 to the light material outlet 6 at the rear side 3, where it exits as light material fraction 16. During operation, the longitudinal axis 10 of the CFS 1 is preferably aligned at an angle of 20° to 40° to the horizontal, so that the transport of the low-density material from the inlet for the material to be separated 5 to the light material outlet 6 is ensured by gravity. Material of higher density, on the other hand, passes from the air core into the separating medium, is pushed radially outward by centrifugal force, and leaves the CFS 1 together with the separating medium through the separating medium outlet 8 as a heavy material fraction 15. The directions of movement of the separating medium and of the material of lower density are thus opposite in the embodiment shown. The separating medium flows in a vortex path from the rear side 3 of the CFS 1 toward the front side 2, whereas low-density particles move from the inlet for the material to be separated 5 at the front side 2 to the light material outlet 6 at the rear side 3 of the CFS.

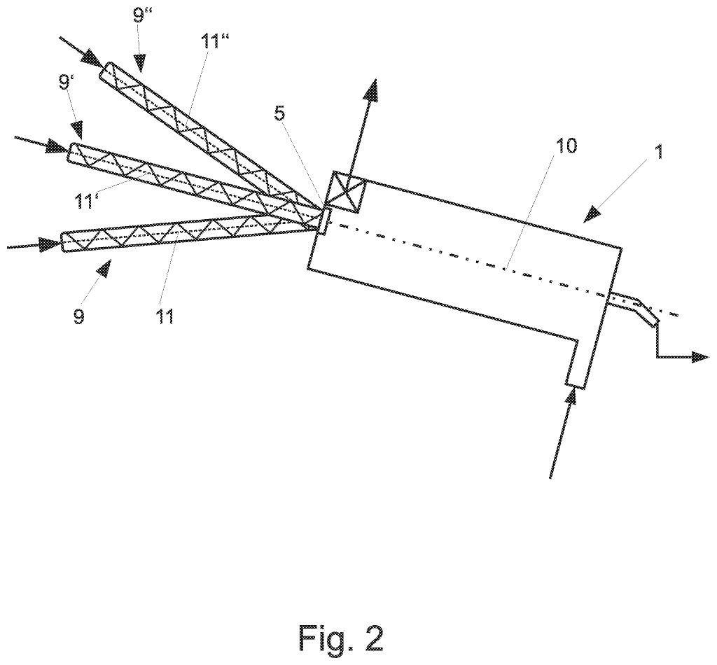

FIG. 2 shows a further preferred embodiment of the apparatus according to the disclosure. The CFS 1 essentially corresponds to the CFS 1 of the embodiment shown in FIG. 1. However, the embodiment shown in FIG. 2 has three forced conveying devices 9, 9′, 9″, which are connected to the inlet for the material to be separated 5 of the CFS 1. The longitudinal axes 11, 11′, 11″ of the forced conveying devices 9, 9′, 9″ are arranged at an angle to each other and to the longitudinal axis 10 of the CFS. The forced conveying devices 9, 9′, 9″ may in turn be connected to receiver tanks (not shown), preferably comprising stirring units or discharge bottoms.

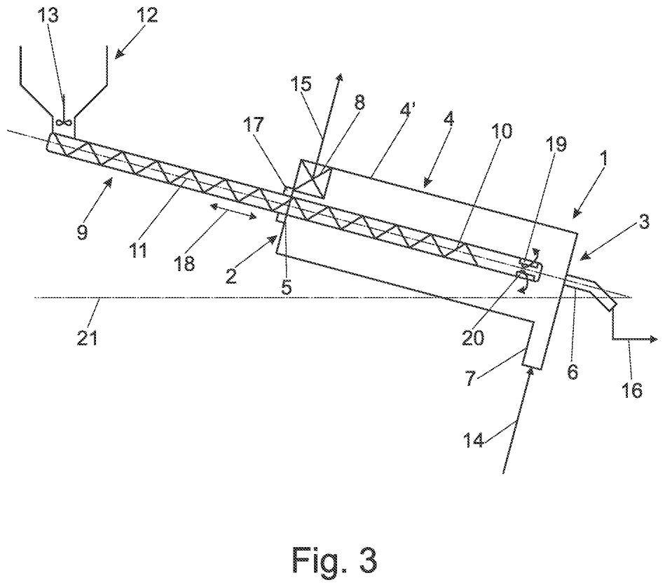

For example, the forced conveying devices 9, 9′, 9″ may terminate in a common forced conveying section in which further forced conveying takes place, for example by means of a further forced conveying device (e.g. with screw conveyor), so that the separating medium is forced into the interior of the housing 4. The common forced conveying section may be formed with a further forced conveying device and may be designed according to the embodiments of the forced conveying device 9 of FIG. 1 or 3.

In connection with the embodiment shown in FIG. 2, the method according to an exemplary embodiment of the disclosure may be carried out essentially analogously to the method described above with respect to FIG. 1. However, in the embodiment shown in FIG. 2, the material to be separated is introduced into the CFS 1 via three separate forced conveying devices 9, 9′, 9″. Advantageously, different material to be separated, for example in terms of composition or size distribution, may be introduced via the separate forced conveying devices 9, 9′, 9″. The forced conveying devices 9, 9′, 9″ may be operated at different conveying speeds adapted to the respective material to be separated.

FIG. 3 shows a forced conveying device 9, the outlet area 19 of which is located inside the housing 4 of the centrifugal force separator 1. The centrifugal force separator 1 is designed similarly to the embodiment in FIG. 1, whereby the forced conveying device 9 is arranged displaceably within the housing 4.

In particular, the centrifugal force separator 1 has a cylindrical housing 4 which has a front side 2 along its longitudinal axis (center axis) 10 at which an inlet for the material to be separated 5 is provided. The housing 4 is in particular inclined with respect to a bottom plane 21 (for example, at an angle between the center axis of the cylindrical housing and the bottom plane 21 of 20 degrees to 70 degrees) and the front face 2, at which the inlet for the material to be separated 5 is provided, is the upper front side. The forced conveying device 9 is coupled to the front side 2 such that the material to be separated is forcibly conveyable through the inlet for the material to be separated 5. The material to be separated is thus guided through the inlet for the material to be separated 5 at least until it enters the housing 4 and is conveyed accordingly by forced conveying.

The forced conveying device 9 has an outlet area 19 from which the material to be separated is forcibly conveyable into the housing 4. For example, the forced conveying device 9 may have a cylindrical outer housing in the interior of which a conveying device, such as a screw conveyor, is arranged. The outlet area 19 is formed at a free end of the forced conveying device 9, wherein the forced conveying device 9 is arranged such that the outlet area 19 is present inside the housing 4, as shown in FIG. 3.

The outlet area 19 has an outlet opening 20 at a sheath surface of the forced conveying device 9. Thus, the material to be separated may be discharged into the housing 4 transversely to the axial direction 11 or to the conveying direction. A discharge transverse to the axial/longitudinal direction 11 may in particular have advantages during separation in that the material to be separated is already introduced with the direction of introduction to the inner sheath surface of the housing 4, thus enabling faster removal of the heavy fraction by means of the edge flow of the separating medium.

The outlet area 19 of the outlet opening 20 is thus present inside the housing 4. The forced conveying device 9 is further arranged to be displaceable along the longitudinal axis 11 along a (particularly translatory) direction of movement 18 relative to the housing 4, such that a position of the outlet area 19 inside the housing 4 is adjustable along the longitudinal axis 11 of the cylindrical housing 4. Thus, the position of the outlet opening 20 may be adjusted as desired inside the housing 4. An outer pipe (pipe section (lining pipe)) of the forced conveying device 9 may be provided and tightened, for example, by means of a seal 17, such as a flat gasket, a flexible sealant or an O-ring, whereby a tight connection may be achieved. Furthermore, the seal 17 may be formed, for example, by means of a sleeve with sealing lips or, if the inlet for the material to be separated is designed as a pipe section (lining pipe), by means of an annular space seal or press ring seal.

Supplementally, it should be noted that “comprising” does not exclude other elements or steps, and “a” or “an” does not exclude a plurality. It should further be noted that features or steps that have been described with reference to any of the above embodiments may also be used in combination with other features or steps of other embodiments described above. Reference signs in the claims are not to be regarded as a limitation.

1.-27. (canceled)

28. A method for separating a material to be separated in a centrifugal force separator, the method comprising:
introducing a separating medium into the centrifugal force separator in such a way that a vortex with an air core is generated inside the centrifugal force separator, and
introducing the material to be separated into the centrifugal force separator via at least one forced conveying device.

29. The method according to claim 28, wherein the material to be separated is introduced via a screw conveyor or a spiral conveyor provided as the forced conveying device.

30. The method according to claim 28, wherein the introduction via the forced conveying device is controlled via a drive unit.

31. The method according to claim 28, wherein the material to be separated is introduced into the forced conveying device from a receiver tank with a discharge bottom or a stirring unit.

32. The method according to claim 28, wherein the material to be separated comprises plastics.

33. The method according to claim 32, wherein the proportion of plastics in the material to be separated is at least 5 wt. %.

34. The method according to claim 28, wherein the material to be separated is moistened before being introduced into the centrifugal force separator.

35. The method according to claim 28, comprising at least one of the following features:
wherein the material to be separated consists of a mixture of solid particles and liquids; and/or
wherein the separating medium comprises at least water; and/or
wherein the separating medium comprises at least oil; and/or
wherein the separating medium comprises at least methanol, ethanol and/or isopropanol; and/or
wherein the separating medium comprises fat solvents.

36. An apparatus for carrying out a method for separating a material to be separated in a centrifugal force separator, the method comprising:
introducing a separating medium into the centrifugal force separator in such a way that a vortex with an air core is generated inside the centrifugal force separator, and
introducing the material to be separated into the centrifugal force separator via at least one forced conveying device;
the apparatus comprising:
a centrifugal force separator having an inlet for the material to be separated for introducing the material to be separated and a separating medium inlet for introducing the separating medium, and
at least one forced conveying device connected to the inlet for the material to be separated.

37. The apparatus according to claim 36, comprising at least one of the following features:
wherein the forced conveying device is a screw conveyor or a spiral conveyor; and/or
wherein the forced conveying device comprises a drive unit; and/or
wherein the forced conveying device is connected to a receiver tank comprising a discharge bottom or a stirring unit.

38. The apparatus according to claim 36,
wherein the centrifugal force separator has a housing with a front side at which an inlet for the material to be separated is provided,
wherein the forced conveying device is coupled to the front side in such a way that the material to be separated is forcibly conveyable through the inlet for the material to be separated.

39. The apparatus according to claim 38,
wherein the forced conveying device has an outlet area from which the material to be separated is forcibly conveyable into the housing.

40. The apparatus according to claim 39,
wherein the outlet area is formed at a free end of the forced conveying device,
wherein the forced conveying device is arranged such that the outlet area is present at the inlet for the material to be separated or in the housing.

41. The apparatus according to claim 40, comprising at least one of the following features:
wherein the outlet area has an outlet opening at a front side at the free end of the forced conveying device; and/or
wherein the outlet area has an outlet opening at a sheath surface of the forced conveying device; and/or
wherein the outlet area is inside the housing.

42. The apparatus according to claim 40,
wherein the forced conveying device is displaceably arranged relative to the housing such that a position of the outlet area inside the housing is adjustable along the longitudinal axis.

43. The apparatus according to claim 42,
wherein the forced conveying device has a longitudinal axis passing through the inlet for the material to be separated,
wherein the forced conveying device is displaceable along the longitudinal axis relative to the housing.

44. The apparatus according to claim 36, wherein the apparatus comprises at least one further forced conveying device connected to the inlet for the material to be separated.

45. The apparatus according to claim 44, wherein the forced conveying devices each have a longitudinal axis, the longitudinal axes being arranged at an angle to each other.

46. The apparatus according to claim 45, wherein the angle between the longitudinal axes of the forced conveying devices is between 10° and 120°.

47. A method for separating a material to be separated in a centrifugal force separator by means of an apparatus, the apparatus comprising:
a centrifugal force separator having an inlet for the material to be separated for introducing material to be separated and a separating medium inlet for introducing a separating medium, and
at least one forced conveying device connected to the inlet for the material to be separated;
the method comprising:
introducing the separating medium into the centrifugal force separator in such a way that a vortex with an air core is generated inside the centrifugal force separator, and
introducing the material to be separated into the centrifugal force separator via at least one forced conveying device.
